(19) United States
(12) Patent Application Publication
(10) Pub. No.: US 2016/0097857 A1
(43) Pub. Date: Apr. 7, 2016

(54) Integrated Targeting Device

(71) Applicants: Michael Cem Gokay, Dayton, OH (US); Michael O. Clark, Dayton, OH (US)

(72) Inventors: Michael Cem Gokay, Dayton, OH (US); Michael O. Clark, Dayton, OH (US)

(21) Appl. No.: 13/762,145

(22) Filed: Feb. 7, 2013

Related U.S. Application Data
(60) Provisional application No. 61/595,772, filed on Feb. 7, 2012.

(51) Int. Cl. G01S 17/02; G01S 17/89; G01S 17/42; H04N 7/18; F41G 3/06

(52) U.S. Cl. CPC G01S 17/023; H04N 7/18; F41G 3/065; G01S 17/42; G01S 17/89

(57) ABSTRACT

An integrated targeting device comprising a housing, the housing comprising an input aperture and an output aperture, a geolocation module configured to estimate the geolocation of a selected target, an imaging module comprising an imaging camera, a laser comprising a seed laser configured to emit a seed laser beam and a moveable optical reflector, a display; and a processor operatively coupled to the laser module, the imaging module, the geolocation module; and the display.

### CROSS REFERENCE TO RELATED APPLICATIONS

This application claims the benefit of U.S. Provisional Application No. 61/595,772, filed Feb. 7, 2012.

### TECHNICAL FIELD

The present disclosure generally relates to targeting devices and, particularly, to integrated targeting devices comprising a targeting system, geolocation system and an observation system.

### BACKGROUND

Lasers may be used in many modern military operations including, for example, laser-guided munitions or weapons. Targeting systems may observe and detect the range of an object and/or designate a target for detection by another weapon system in order to deliver the weapon to the designated target. Current systems use multiple devices to perform the operations described with precision. Such devices may include, for example, a GPS system, observation binoculars, laser rangefinder, digital magnetic compass, and laser designator. However, the weight of kits having multiple devices may range from 14 lbs to 35 lbs, with total mission kits, which may further include weapons, ammunition, body armor, and other supplies, ranging from 80 lbs to 160 lbs. Further, the amount of time to set up multiple devices to have adequate boresight alignment between the devices can be substantial.

Integrating multiple devices into one integrated device can also be a challenge. Thermal management issues can result, which may include generation of a relatively large amount of heat energy within the integrated device due to the close proximity of multiple components, as well as, due to the energy levels involved in the creation of a laser beam. In addition, power levels required to operate multiple devices can be quite high and difficult to minimize device power consumption.

Therefore, integrated targeting devices are needed that are more efficient, reduce the amount of heat generated, and are compact, having a smaller size, volume and weight.

### SUMMARY

In one embodiment, an integrated targeting device is disclosed. The integrated targeting device comprises a housing, the housing comprising an input aperture and an output aperture; a geolocation module configured to estimate the geolocation of a selected target; an imaging module optically aligned with the input aperture, the imaging module comprising an infrared focal plane array configured to receive electromagnetic radiation in the near infrared and short wavelength infrared spectral range; a laser module optically aligned with the output aperture, the laser module comprising a seed laser configured to emit a seed laser beam; and a moveable optical reflector configured to move between a first position and a second position, wherein when the optical reflector is in the first position, the seed laser beam is directed through a first optical path configured to emit a laser designator beam having a first wavelength onto the selected target, and when the optical reflector is in the second position, the seed laser beam is directed through a second optical path configured to emit a laser rangefinder beam having a second wavelength onto the selected target, wherein the first wavelength≠the second wavelength; a rangefinder module optically aligned with the input aperture, the rangefinder module comprising a rangefinder pin detector configured to determine a flight time of the rangefinder laser beam; a display associated with the imaging module, the display configured to display an image output; and a processor operatively coupled to the laser module, the imaging module, the geolocation module, the rangefinder module and the display.

In another embodiment, a modular integrated targeting device is disclosed. The modular integrated targeting device comprises: housing, the housing comprising an input aperture, a laser output aperture and a laser pointer output aperture; a geolocation module, the geolocation module comprising a processor, a display, and at least one of a celestial/inertial navigation system, a global positioning system (GPS), or a digital magnetic compass; and a targeting module, the targeting module comprising: a laser comprising: a seed laser configured to emit a seed laser beam; and a moveable optical reflector configured to move between a first position and a second position, wherein when the optical reflector is in the first position, the seed laser beam is directed through a first optical path configured to emit a designator laser beam having a first wavelength toward the selected target, and when the optical reflector is in the second position, the seed laser beam is directed through a second optical path configured to emit a laser rangefinder beam having a second wavelength onto the selected target, wherein the first wavelength≠the second wavelength; a rangefinder pin detector configured to determine a flight time of the rangefinder laser beam; and an input optical train optically aligned with input aperture, the imaging module and the rangefinder pin detector, the input optical train comprising one or more lenses and configured to direct incoming electromagnetic radiation from the input aperture to the imaging module and the rangefinder pin detector.

Additional features and advantages of the embodiments for integrated targeting devices, and uses thereof described herein will be set forth in the detailed description which follows, and in part will be readily apparent to those skilled in the art from that description or recognized by practicing the embodiments described herein, including the detailed description which follows, the claims, and the appended drawings.

Both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative in nature and not intended to limit the inventions defined by the claims. The following description of the illustrative embodiments can be understood when read in conjunction with the following drawings. In embodiments herein:

FIGS. 1A-1C pictorially depict an integrated targeting device having a housing;

FIGS. 2A-2B pictorially depict interior components of a geolocation module;

FIG. 3 schematically depict the interconnects between modular components of an integrated targeting device;

FIGS. 4A-4B depict a notional GUI/display;

FIGS. 5A-5C pictorially depict interior components of a targeting module;

FIG. 6 schematically depicts a notional input aperture beam splitter;

FIG. 7 schematically depicts a notional color correcting optic train;

FIG. 8 schematically depicts a notional color correcting optic train;

FIG. 9 schematically depicts a notional optical layout for a laser module having a common output port;

FIG. 10A pictorially depicts an exterior of an integrated targeting device; and

FIG. 10B schematically depicts a notional buttonology and operational workflow.

### DETAILED DESCRIPTION

Reference will now be made in detail to embodiments of integrated targeting devices, examples of which are illustrated in the accompanying drawings. Whenever possible, the same reference numerals will be used throughout the drawings to refer to the same or like parts. Disclosed herein are integrated targeting devices that combine multiple devices required to observe, geolocate, and designate a target, into a single device. Those devices may include, but are not limited to, a laser rangefinder and illuminator, a laser designator, observation binoculars, a digital camera, a global positioning system, a true north location system, and a digital magnetic compass. The integrated targeting device can provide a user with a device having a reduced size, weight and power requirements versus carrying and using each individual device.

In certain illustrative embodiments described herein, integrated targeting devices are disclosed comprising a housing, a geolocation system, an observation system, a laser targeting module, a display, and a processor operatively coupled to the geolocation system, the observation system, the laser module and the display. The integrated targeting device may further comprise a user interface and a power supply. The integrated targeting device may be handheld and compact. As used herein, the term “compact” refers to a device that has total linear dimensions (avg. length plus by avg. diameter) of no more than about 15 inches, about 13 inches, or about 12 inches.

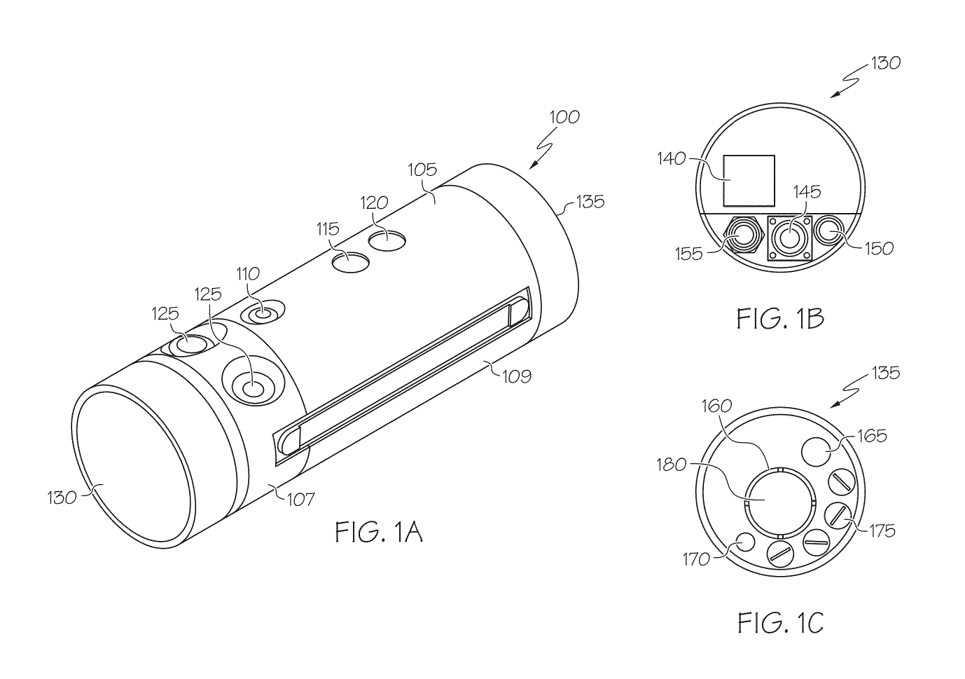

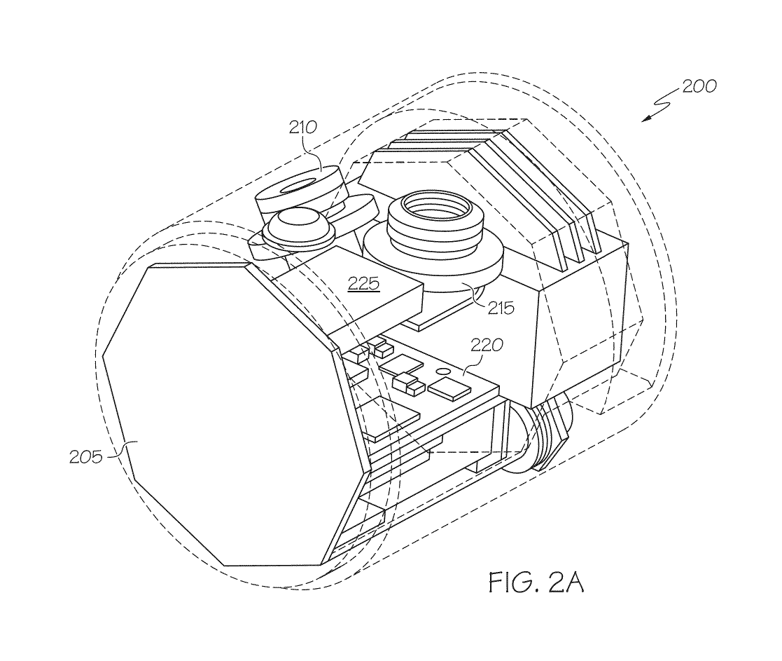

Referring to FIGS. 1A-1C, depicted is an exterior of an illustrative integrated targeting device (100) having a housing (105). The housing (105) may be generally elongated and adapted to be received within and gripped by the hand of a user. The housing (105) defines a compartment within the interior that is adapted to receive the components of the integrated targeting device (100). The housing (105) is cylindrical in shape and has a length of about 9 in. and a diameter of about 3.5 in. Of course, the housing (105) may be adapted to other suitable lengths, sizes and shape configurations in order to receive or house some or all of the components of the integrated targeting device (100).

In embodiments of the integrated targeting devices described herein, the housing may comprise a hollow body having an outer surface, an inner surface, a front end and a rear end. In some embodiments, the hollow body may be a unibody comprising one single (i.e., monolithic) piece of material that is suitably machined (e.g., drilled, hogged out, etc.) as necessary to contain some or all of the components. In other embodiments, the hollow body may comprise two or more cooperating pieces of material that form a body or unibody. The housing may be formed from metal, plastic, or composite material. Examples of suitable metals may include, but are not limited to, aluminum or titanium. Examples of suitable plastics include, but are not limited to, polycarbonate resin, polyacrylate, polystyrene, etc. Examples of suitable composite materials may include, but are not limited to, fiber reinforced polymer, Bayblend®, or acrylonitrile butadiene styrene. In some embodiments, the housing may further comprise covers that may attach to the housing in order to cover and/or protect the components contained therein, and may include a front cover and a rear cover.

The housing may be equivalent to the size of a standard military water bottle such as, for example, a Nalgene® bottle, thus allowing military personnel to easily carry the integrated targeting device. In some embodiments, the housing may be less than about two volumetric liters, less than about one and a half volumetric liters, or less than about one volumetric liter. The housing may have an outer diameter of less than about 5 in., about 4 in., about 3.5 in., about 3 in., or about 2.5 in. The housing may have a length of less than about 11 in., about 10 in., about 9 in., or about 8 in. In some embodiments, the housing is sized and shaped to allow for the integrated targeting device to utilize a standard water bottle pouch or a sniper rifle attachment such as, for example Nalgene® MOLLE-compatible pouch.

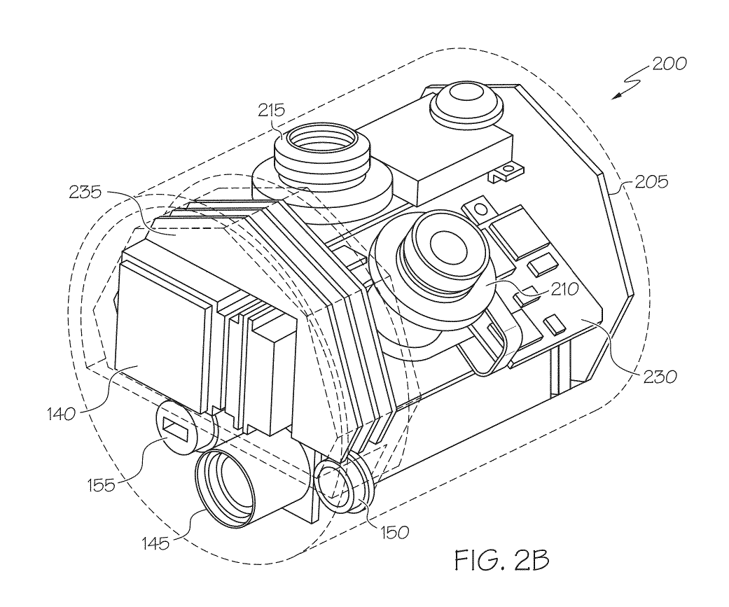

Referring to FIG. 1A, the housing (105) has a first section (107) to contain a geolocation module and a processor, and a second section (109) to contain a targeting module. The first section (107) of housing (105) also has celestial day/night lenses (125) for imaging celestial objects. Further depicted in FIGS. 2A and 2B are two perspective views of the interior of the first section (107), which contains the geolocation module (200) and processor (205). The geolocation module (200) is depicted comprising a celestial/inertial navigation system comprising a celestial day lens (215) and a night lens (210) and inertial sensor (220), a global positioning system (225), and a digital magnetic compass (230). Also depicted are printed circuit boards (235) for the geolocation module.

In embodiments of the integrated targeting devices described herein, the geolocation module is disposed within the housing and may be used to obtain location data for a target. The module may operate both day and night. The geolocation module may generally comprise at least one of a celestial/inertial navigation system, a global positioning system (GPS), or a digital magnetic compass. The celestial/inertial navigation system uses celestial objects with known positions as absolute references to estimate the location of a target relative to an observer's position. Celestial objects may include all recognizable stars, planets, the sun and the moon. The celestial/inertial navigation system may comprise a celestial sensor and at least one celestial camera for imaging celestial objects. The celestial/inertial navigation system may further comprise one or more inertial sensors, including, for example, one or more gyroscopes and accelerometers, to produce raw inertial measurement data. A digital magnetic compass may measure the Earth's magnetic field in order to provide target location data.

The GPS system uses signals transmitted from GPS satellites to acquire current location information. The GPS system may comprise a GPS receiver configured to receive a GPS signal from GPS satellites. In some embodiments, the GPS receiver may simultaneously detect signals from several satellites and process them to calculate the desired parameters, such as position. The GPS system may also comprise an anti-spoofing module. The anti-spoofing module is configured to allow the GPS system to receive a satellite signal and an anti-spoof (or verification) signal. The anti-spoof signal prevents jamming signals from being accepted as or interfering with actual satellite signals, and operates as a way to verify that a particular satellite signal is authentic. In some embodiments, the GPS receiver may be configured to detect anti-spoof signals. In other embodiments, the anti-spoofing module may comprise a separate anti-spoof receiver configured to detect anti-spoof signals. In further embodiments, the anti-spoofing module may comprise means (e.g., modulator or signal filter) for separating the anti-spoof signal from the satellite signal.

The geolocation module can provide for the use of a single geolocation system or a combination of two or more of the geolocation systems depending upon accuracy to provide target location data relative to an observer's position. In some embodiments, the integrated targeting device uses the celestial/inertial navigation system. In other embodiments, where the celestial/inertial navigation system is unavailable, the integrated targeting device uses the global positioning system. In further embodiments, where the global positioning system and celestial/inertial navigation systems are unavailable, the integrated targeting device uses the digital magnetic compass. In even further embodiments, the integrated targeting device uses a combination of two or more systems to provide target location data relative to an observer's position.

In some embodiments, the integrated targeting devices uses a celestial with inertial geolocation function to provide the most accurate geolocation data. The celestial/inertial navigation system can have accuracies of less than about 3 angular mils, about 2 angular mils, or about 1 angular mil. The system may comprise two celestial cameras that convey the known position of celestial objects along with inertial sensors, together which provide position data, including azimuth and elevation data.

In embodiments of the integrated targeting devices described herein, the processor is disposed within the housing and in communication with a geolocation module, an imaging module, a laser module, and a display. The processor generates and/or receives signals from each of the modules and the display to control operation, perform data processing and/or monitor the operating states. Examples of suitable processors may include, but is not limited to, microprocessors, processor-based controllers, or other suitable signal processors capable of receiving and/or generating signals.

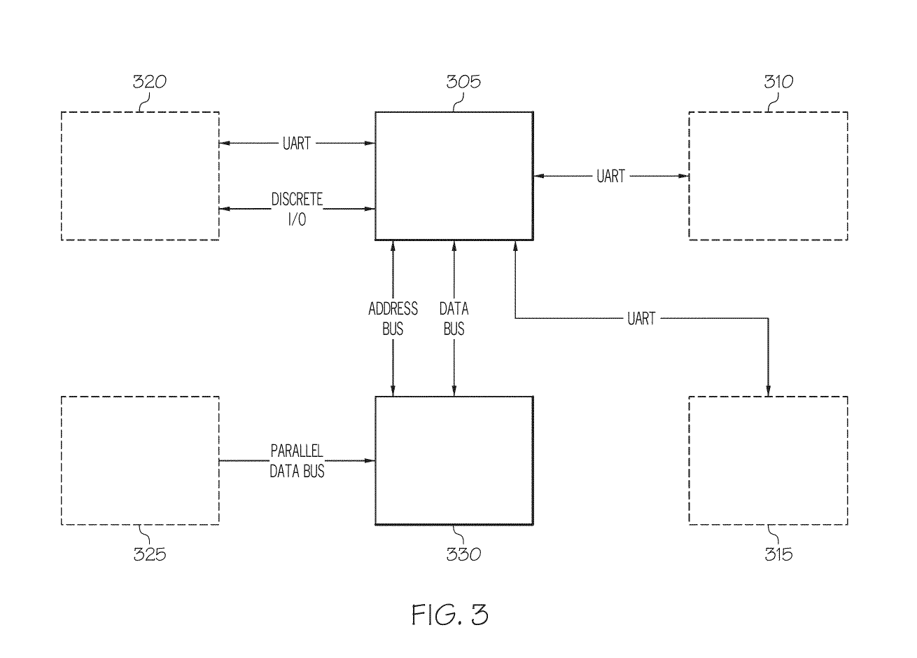

FIG. 3 depicts a block diagram showing an exemplary connectivity relationship between the processor (305) and the celestial/inertial navigation system (310), the GPS system (315), the laser module (320), and the imaging module, which includes the imaging camera (325) and a field programmable gate array (FPGA) (330). The processor (305) is connected to the celestial/inertial navigation system (310) using universal asynchronous receiver/transmitter (UART) integrated board. Similarly, the GPS system (315) is also connected to the processor (305) using a UART connection. The processor (305) is connected to the laser module (320) using a UART connection as well as a discrete input/output module. The FPGA (330) is connected to the processor (305) using an address bus and data bus. The FPGA (330) is connected to the imaging camera (325) using a parallel data bus.

In embodiments herein, the processor may be configured or programmed for receiving video data from the imaging module and communicating the video data and/or commands to a display. The commands may comprise on/off commands, imaging system status, conditions of the imaging systems, such as temperature, power usage, and illumination levels, time synchronization of the camera(s) and/or light sources, temperature regulation control, mode identification, error messages, and other commands for operating the integrated targeting device. In embodiments herein, the processor may be configured or programmed for video image signal processing as may be required to correct video signals, to make signal value offsets and gain adjustments for reducing signal noise, to adjust brightness and contrast to desired levels, to replace dead pixels with data values predicted from surrounding pixel data values, and to enhance image detail such as by sharpening edges or the like.

In embodiments herein, the processor may be used to determine target ranges, target geo-locations, target temperatures and/or other data about the target area as may be required and to generate target meta data. The target meta data may comprise video overlays such as a cursor on target and or graphical data display that is updated in each video frame. In some embodiments, the processor may packetize the data and send to a remote laptop.

The integrated targeting device may further comprise other components required to perform operations of the integrated targeting device. For example, the integrated targeting device may comprise non-volatile memory devices such as flash memory and electrically erasable programmable memory (EEPROM) for storing the programs and other data used to power up and manage the operation of, including sending/receiving data and commands, elements housed inside the integrated targeting device.

Referring to FIG. 1A, the housing (105) may further have end caps (130, 135) configured to enclose the ends of housing (105). The end caps (130, 135) further have a locking mechanism that is user actuatable to open or close end caps (130, 135). In one example, end caps (130, 135) may be connected to housing (105) using convention snap-fit connections. In another example, end caps (130, 135) may include a hinge on one side connecting the end caps to housing (130) and have a locking mechanism (e.g., a snap tab connector) on the side of the end caps opposite the hinge. In yet another example end caps (130, 135) may be a rubberized material fastened by straps onto the housing (105), which the straps can then be stretched allowing the caps (130, 135) to move to the elongated portion of the device and stay snug during operation, without requiring them to be detached. In yet another example, end caps (130, 135) may be threadingly engaged to housing (130). It is understood that end caps (130, 135) may be permanently or removably connected to housing (130) using a variety of convention connection methods, or any combinations thereof.

Referring to FIG. 1B, depicted is an illustrative embodiment of end cap (130). End cap (130) comprises openings that overlie a display (140), a key fill (145), a power connector (150), and a USB connector (155). In embodiments of the integrated targeting devices described herein, the display is a visual image display that may display graphics, images, video, data, GUI elements, etc. The display is configured to display visible images, short wavelength infrared images, laser designator spots, and laser range finder spots. The display may include liquid crystal display (LCD) displays, organic light emitting diode (OLED) displays, thin film transistor (TFT) displays, or other suitable displays for displaying graphics, images, video, data, GUI elements, etc. In some examples, the display may also be a touchscreen that detects the presence and location of a touch (finger or stylus) within the display area.

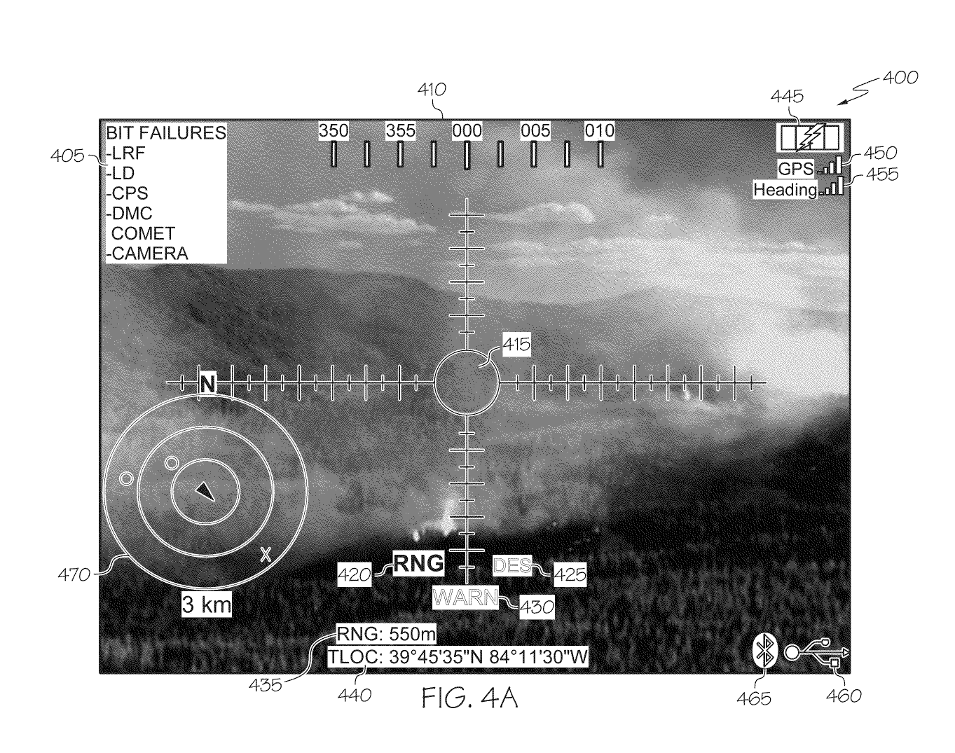

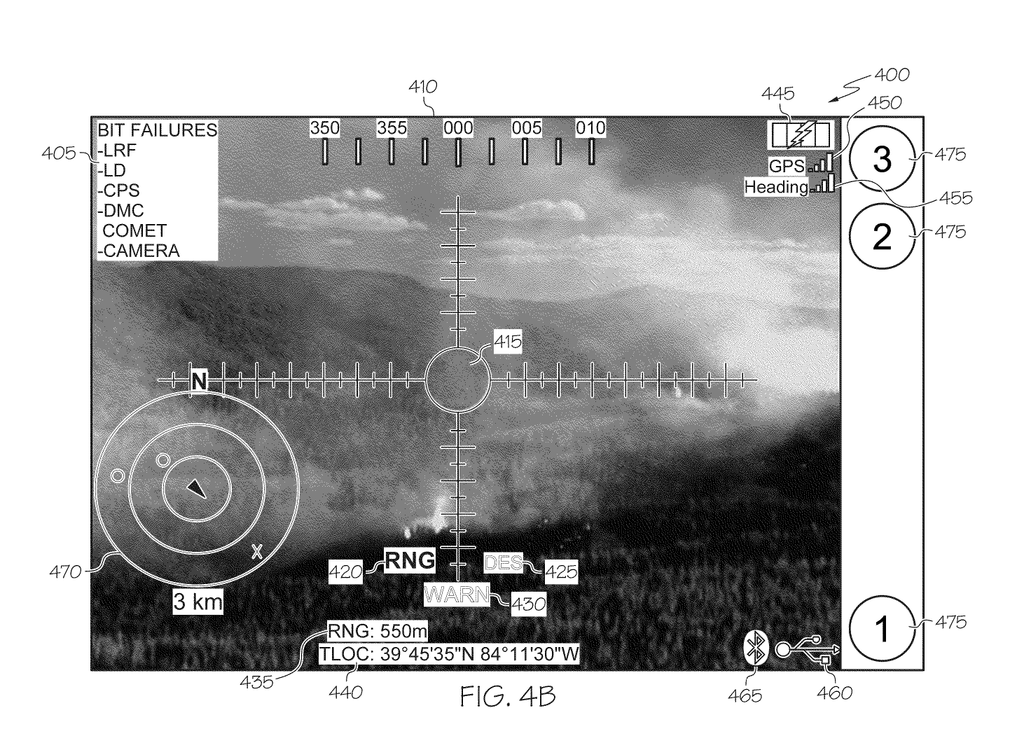

Referring to FIGS. 4A and 4B, depicted are illustrative display screens (400) having a graphical user interface (GUI). FIG. 4A depicts an illustrative display screen (400) on an integrated targeting device. The display screen (400) features text in a green color to signify that a module is on and being used, and red color when a module is off and not being used, or to indicate a failure of a module or system; however, it is understood that other colors and/or indicia may be used as well. In the upper left corner of the screen are built-in test flags (405) that will illuminate if an error has occurred affecting that particular module/system. In the top middle portion of the screen, depicted is a mil gradient (410) used to estimate distance to the left and right of a particular location. In the center of the screen, a standard mil dot (415) is also depicted. Just below the standard mil dot (415) are the labels “RNG” (420), “DES” (425), and “WARN” (430) in red or green colored text depending upon whether the particular module is active. RNG (420) stands for ranging and refers to when the integrated targeting device is in laser rangefinder mode. DES (425) stands for designating and refers to when the integrated targeting device is in laser designation mode. WARN (430) stands for warning and refers to when the user of an integrated targeting device is too close to the target. In some embodiments, the warning may be active when a user of an integrated targeting device is within about 3 km, about 2 km, about 1 km, or about 0.5 km of the target. Below the labels (420, 425, 430) are RNG (435), which stands for ranging and provides the distance in meters from the target, and TLOC (440), which stands for geo-location and provides the latitude and longitude of the target. In the upper right corner of the display screen (400), is a batter life indicator (445), a GPS signal strength indicator (450), and a geolocation system performance indicator (455). In the lower right corner of the display screen (400) is a USB connectivity indicator (460) and a bluetooth connectivity indicator (465), both of which indicate if there's connectivity via USB or bluetooth to an external device. The lower left corner depicts a puck display (470) that provides situational awareness for a user. The triangle in the center indicates the position of the user, the circles indicate the position of friendly individuals/entities, and the “x” indicating the position of the enemy forces. Of course, other designators may be used to indicate the position of the user, friendly individuals/entities, or targets. The circular range rings surrounding the triangle indicate the distance between a user in the center of the puck display (470) and friendly individuals/entities, and targets. The processor (305) may further be able to detect slight variations in the pulse repetition frequency (PRF) patterns, which allows each user on the battlefield to be specifically identified by employing configurable unique signatures to the output of each laser designator. This may prevent fratricide by provided situational awareness data identifying the positions of friendly and enemy forces

FIG. 4B further depicts a display screen as depicted on an external device, such as a laptop, where the integrated targeting device is being operated remotely, as will be further described below. The display buttons (475) are the same as the display buttons that are on an integrated targeting device. Thus, to operate the integrated targeting device remotely, a user would use the display buttons (475) shown on the screen in the same manner that the buttons on an integrated targeting device would be used.

In embodiments herein, the display (140) can provide effective imaging, particularly for long-range applications. Thus, there is less of a need for pass-thru optics, and as such, pass-thru optics may be eliminated from the integrated targeting device. Further, a user may benefit from the elimination of pass-thru optics as the user is protected from harmful and potentially blinding incoming wavelengths (e.g., 1064 nm) reaching the user's eye.

In embodiments of the integrated targeting devices described herein, the power supply source may be an internal power cell, which is further described below, an external power source, or both. The power connector (150) may be used as a connection to an external power source. The integrated targeting device can be augmented through any approximate 22V power source through power adapter and allows for a variety of power connections including, but not limited to, the BAO (Battlefield Air Operations) Kit BRITES (Battlefield Renewable Integrated Tactical Energy System) connector, a military battery (e.g., BA5590), battery jumper connection, DC vehicle auxiliary power, AC, etc. The external power source can extend the life of the integrated targeting device for as long as the user needs and/or can support it with power. If the external power coming in to the integrated targeting device is greater than what is being consumed, the internally batteries can be recharged. This recharge and hot swap capability allows the unit to be continuously used whether running off batteries or recharging the system's internal power cells. The device's power supply may also have a hot swap capability wherein a device component may be replaced while the device continues to run, maintaining normal operation. The device can either be transitioned between various power supplies (for example AC, vehicle DC outlet, BA5590 or other military battery, etc.) through its power connector or the internal batteries can be changed one battery pack/cell at a time. The internal power cells coupled with the overall low system power consumption allows the integrated targeting device to operate on standalone power for an extended period. In some embodiments, the integrated targeting device may use approximately six Li-ion or equivalent rechargeable battery cells.

In embodiments of the integrated targeting devices described herein, the key fill connector (145) may be used as a connection to a key fill device used to load cryptographic keys into various systems of the integrated targeting device. In some examples, the key fill connector (145) may be used to load cryptographic keys for the Selective Availability Anti-Spoofing module, which supports the global positioning system.

In embodiments of the integrated targeting devices described herein, a USB port (155) may be used to provide USB connectivity. In some embodiments, the USB port (155) may be used to connect to a laptop for transmitting information (e.g., target location data, imagery, etc.) from the integrated targeting device to the laptop. In other embodiments, the USB port (155) may be used to receive information from an external device to the integrated targeting device. Such information may include, for example, situational awareness data.

In some embodiments, the USB port (155) may be used to connect to an external interface that may provide the user with remote control of the integrated targeting device. Referring to FIG. 4B, the display screen (400) may be displayed on a laptop computer, a wrist computer, a helmet display, micro computers or other similar external device. Control buttons (475) can be displayed and used as shown in FIG. 4B. While a three button embodiment is depicted, a two button embodiment may also be used. The button functionality/controls may be remotely accessed by a keyboard or using a GUI screen on a laptop. In other embodiments, a network adapter may be used, depending upon communication distance requirements, by plugging the network adapter into the integrated targeting device. The network adapter may utilize signals such as Bluetooth, WIFI or other similar connection, e.g., a military network connection. The network adapter or other external device may import and export target position data, and plot this information on the GUI so that a user can have situational awareness about his/her proximity to enemy targets as well as to friendly targets. The network adapter or other external device may warn the user if a munitions strike may jeopardize themselves or other friendly forces.

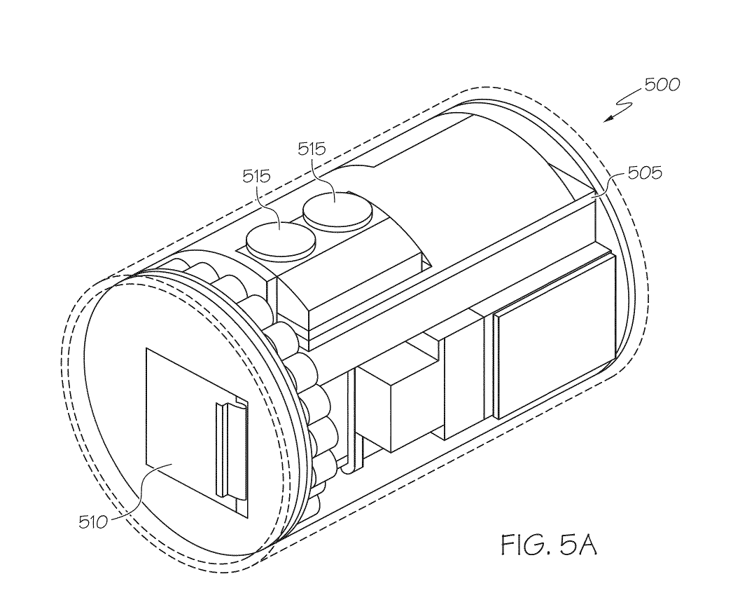

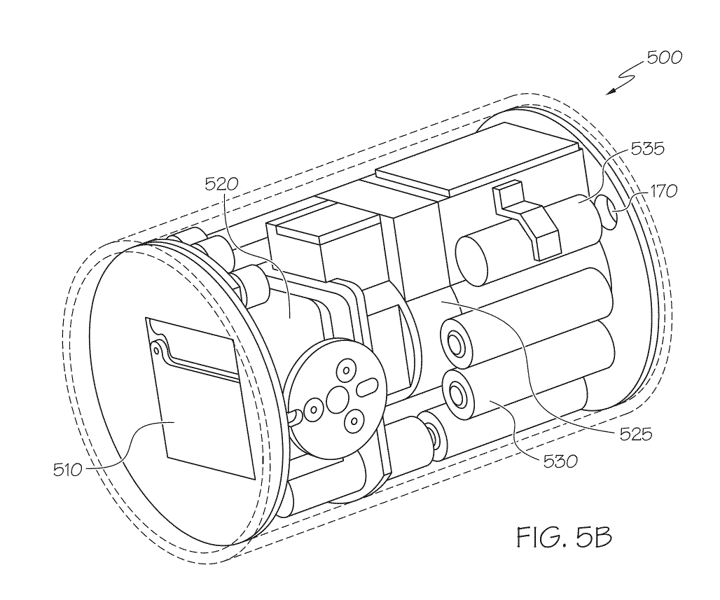

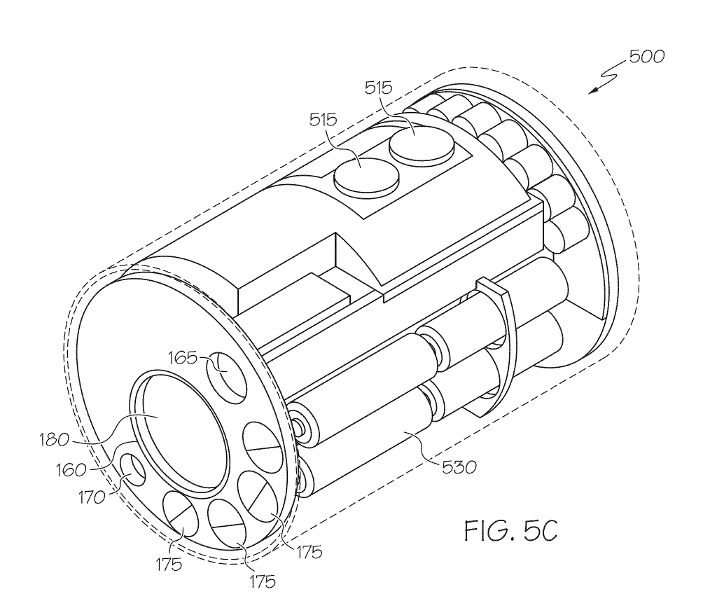

Referring to FIGS. 5A-5C, depicted is the second section (109) containing the targeting module (500). The targeting module (500) may include a laser module (505), imaging camera printed circuit board (510), buttons (515), imaging camera (520), input optical train (525), internal power cells (530), and laser pointer (535). Referring to FIGS. 1C and 5C, end cap (135) is depicted openings that overlie a multi-functional input aperture (160), rangefinder/designator laser output aperture (165), and laser pointer aperture (170). Also depicted are battery caps (175), which are integral to end cap (135).

In embodiments of the integrated targeting devices described herein, the multi-functional input aperture (160) is a single aperture configured for use with the laser designator spot detection, the laser rangefinder and illuminator system, and the visible/short wavelength infrared camera system. The input optical train (525) collects light passing through the multi-functional input aperture (160) and directs the optical path of the light to the imaging camera (520). The multi-functional input aperture (160), the input optical train (525) and the imaging camera (520) are optically aligned. In some embodiments, the multi-functional input aperture (160), the input optical train (525) and the imaging camera (520) are boresighted.

The multi-functional input aperture (160) includes an input aperture lens (180) that may be sized to maximize the amount of light brought to the imaging camera. In one embodiment, the size of the input aperture lens (180) may range from about 20 mm to about 50 mm in diameter, from about 25 mm to about 45 mm in diameter, or from about 30 mm to about 40 mm in diameter. The input aperture lens (180) may have several optical coatings applied, including, for example, anti-reflective (AR) coatings. The coatings are designed to allow the passage of electromagnetic radiation having specific wavelengths within about 380 nm to about 2500 nm, including, for example, visible light, eyesafe laser rangefinder energy between 1560 nm and about 1570 nm, non-eyesafe laser designator energy of about 1064 nm, and night vision goggle compatible pointer laser energy ranging from about 800 nm to about 900 nm.

In embodiments of the integrated targeting devices described herein, the input optical train collects light passing through the multi-functional input aperture and directs the optical path of the light. The optical path of the light may be directed to, for example, an infrared imaging camera, a visible light imaging camera, or a range finder pin detector. The input optical train comprises one or more optical elements, including, for example, one or more beam splitters, interferometers, collimators, reflectors, beam benders, or other optical elements capable of directing, separating, bouncing, transmitting or focusing electromagnetic radiation. In some embodiments, the input optical train may include an optical separator that separates electromagnetic radiation into a visible light component and an infrared component. In other embodiments, the input optical train may comprise visible light optics adapted to capture a visible light component and infrared optics adapted to capture a infrared component.

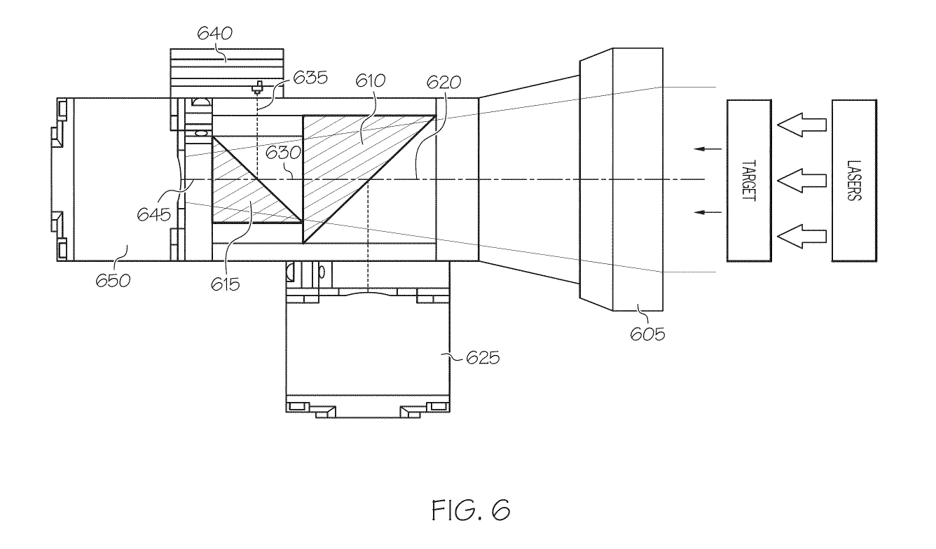

Referring to FIG. 6, depicted is an illustrative embodiment of an input optical system optically aligned with a multi-functional input aperture lens (605). The input optical system may comprise a first beam splitter (610) and second beam splitter (615). The beam splitters (610, 615) are configured to reflect a portion of incoming light, and transmit a portion of the light therethrough. The incoming light may include visible light, and electromagnetic radiation having near infrared wavelengths and short wavelength infrared wavelengths. The first beam splitter (610) reflects a portion of incoming light (620), having wavelengths in the visible light region, to a visible light focal plane array (625). The first beam splitter (610) also transmits a portion of the light (630) therethrough. The transmitted light (630) reaches the second beam splitter (615) where a portion of the light (635) is divided and reflected to a rangefinder module comprising a range finder pin detector (640) configured to determine a flight time of a rangefinder laser beam, and a portion of the light is transmitted (645) to a camera focal plane array (650) configured to receive electromagnetic radiation in the near infrared and short wavelength infrared spectral range, such as from the laser designator, the eye spot rangefinder, and the short wavelength infrared camera.

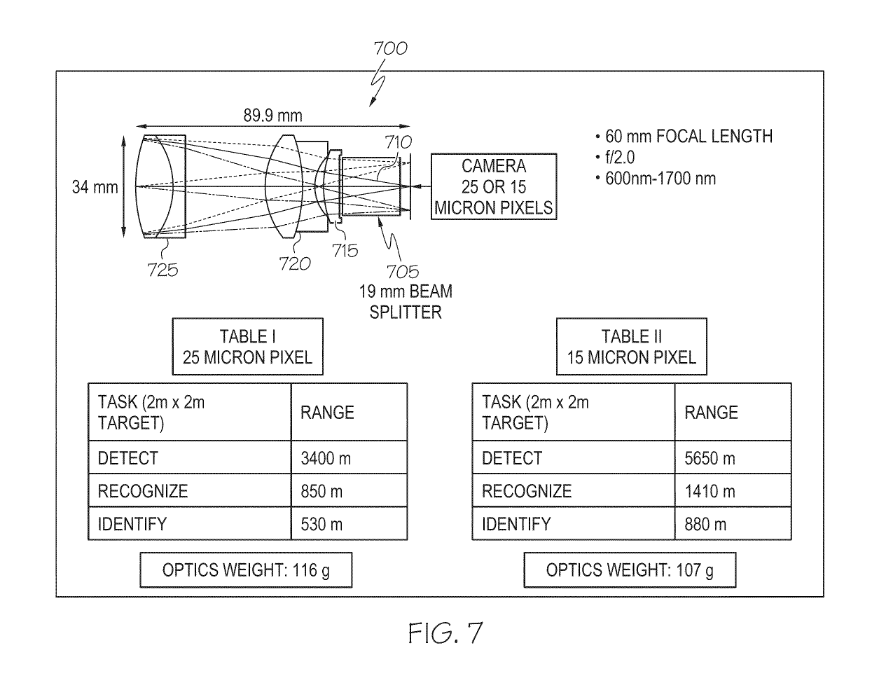

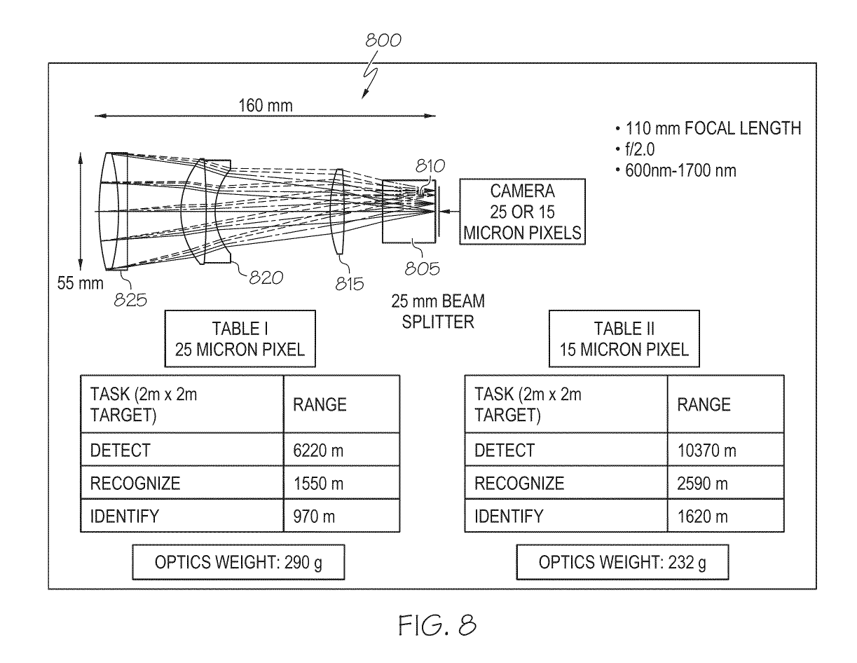

Referring to FIGS. 7 and 8, depicted are illustrative embodiments of a color correcting input optical system. Referring to FIG. 7 the color correcting optical system (700) depicted may include a beam splitter (705), a camera focal plane array operable to capture electromagnetic radiation in the 600 nm to 1700 nm spectrum (710), an input aperture lens (715) and color correcting lenses (720, 725) that correct optical aberrations that would otherwise reduce the optical efficiency and overall light focused on the focal plane array of a camera module. The optical system allows for a significant size and weight reduction, particularly for the target detection range that is achieved. Tables I and II in FIG. 7 use Johnson criteria to predict the performance of a camera focal plane array to “detect”, “recognize” and “identify” a 2 meter (2 m)×2 meter (2 m) target. Table I predicts the performance of an camera focal plane array having a 25×25 micron pixel size to detect, recognize, and identify the target object. Table II predicts the performance of an camera focal plane array with a 15×15 micron pixel size to detect, recognize, and identify the target object. As shown, Tables I and II illustrate the various distances that each camera focal plane array is capable of detecting, recognizing, or identifying the 2 m×2 m target. FIG. 8 depicts a color correcting optical system (800) having a length of about 160 mm and an input aperture lens (815) diameter of about 55 mm. Also depicted are a beam splitter (805), a camera focal plane array operable to capture electromagnetic radiation in the 600 nm to 1700 nm spectrum (810), and color correcting lenses (820, 825). Tables I and II in FIG. 8 use Johnson criteria to predict the performance of an camera focal plane array to “detect”, “recognize” and “identify” a 2 meter×2 meter target. Table I predicts the performance of a camera focal plane array with a 25×25 micron pixel size to detect, recognize, and identify the target object. Table II predicts the performance of an camera focal plane array with 15×15 micron pixel size to detect, recognize, and identify the target object. As shown, Tables I and II illustrate the various distances that each camera focal plane array is capable of detecting, recognizing, or identifying the 2 m×2 m target. Further, FIGS. 7 and 8 show that while having larger optics can significantly increase the range of an camera focal plane array, larger optics will also increase the overall size and weight of the integrated targeting device.

In embodiments of the integrated targeting devices described herein, the laser pointer aperture (170) is optically aligned with the laser pointer (535). The laser pointer may be operable during the day and/or night. It comprises a laser that is configured to emit a laser beam. The laser beam may be a continuous wave beam or a pulse beam. The laser may operate in an eye-safe wavelength range that is readily detectable using an imaging camera. In some embodiments, the laser pointer operates in the near infrared wavelength spectrum, including, for example, from about 800 nm to about 900 nm. In other embodiments, the laser pointer operates in the near ultraviolet wavelength spectrum, including, for example, from about 350 nm to about 400 nm.

In embodiments of the integrated targeting devices described herein, an imaging module comprises an imaging camera. The imaging module may further comprise an imaging camera printed circuit board (510). In some embodiments, the imaging camera may comprise a visible camera and/or an infrared camera. In some embodiments, the imaging module may simply comprise a combined visible light/infrared camera. The imaging camera, which may include the visible and/or infrared camera, may be optically aligned with the multi-functional input aperture (160) and input optical train (525). The visible camera may comprise a visible light focal plane array comprising a plurality of visible light photo sensors configured to receive the visible light component and output a first image signal of a visible light image. The visible light image focal plane array may be operable to capture electromagnetic radiation in the 380 nm to 700 nm spectrum. The infrared camera may comprise an infrared focal plane array comprising a plurality of infrared photosensors configured to receive an infrared component and output a second image signal of an infrared image. The infrared focal plane array is operable to capture electromagnetic radiation in the 700 nm to 2500 nm spectrum. The first image signal may be output to a display where a visible light image is displayed. The second image signal may be output to the display where an infrared image is displayed. In some embodiments, the first image signal and the second image signal are combined and output to the display where a combined image is displayed.

The imaging module can also allow visualization of the laser spots the device will produce at various wavelengths, including, for example, at 860 nm for the laser pointer, at 1064 nm for the laser designator, and at 1550 nm for the laser rangefinder. In operation, a user may use the laser pointer to point out a particular target. In operation, the laser designator may also point out or designate a target of interest using a wavelength different from the laser pointer. In operation, the laser rangefinder “spot” may be used to determine the particular target used in measuring a rangefinding distance.]

In embodiments of the integrated targeting devices described herein, error correction of the image may be accomplished through a number of techniques using the processor. In some embodiments, a multiple frame image overlay can be accomplished by the processor, the processor being programmed to see the image on large area X/Y sensor/detector imaging module with eyesafe rangefinder laser/designator spots superimposed on the image one at a time. In some embodiments, a time averaging technique can be used to enhance the spot intensities. In other embodiments, the processor may be programmed to superimpose each laser spot on a common field of view of the target image so that the laser beams can be moved using a motorized rangefinder laser or designator laser beam to actively boresight using error correcting risleys until the spots are aligned and overlaid on the target image. In further embodiments, the user holding the integrated targeting device may move the targeting device and the processor is programmed to overlay relevant laser spots, one at a time, on the target image. This would entail very small movements of the integrated targeting device due to the long targeting distances involved. In even further embodiments, the processor may be programmed to implement pulse width modulation techniques may be used to alter the duty cycle, thereby reducing the amount of backlight interference and enhancing the target image and/or the laser spot image. In even further embodiments, the processor may be programmed to sync the camera with the lasers and variable gain control to provide different luminescence of targets, particularly where high gain is used for low light conditions. In even further embodiments, the processor may be programmed to employ a combination of one or more of the above techniques.

In embodiments of the integrated targeting devices described herein, the internal power cells (530) may comprise Li-Ion battery cells or other equivalent rechargeable battery cells (AA sized). In some embodiments, the stand alone power generated from the internal power cells (530) can provide operation of the integrated targeting device for up to about 55 minutes of observation, 55 ten second designation shots, or 125 target geolocation measurements. Of course, other power cells may be used to provide operation of the integrated targeting device such that longer periods of observation, longer and additional designation shots, or additional target geolocation measurements may be had. The integrated targeting device may be a true standalone portable multi-function device capable of replacing GPS, rangefinder, designator, among other devices. The internal power cells (530) are aligned with battery caps (175) such that the battery caps may be removed to replace internal power cells (530) as needed. As depicted in FIG. 5C, each battery cap (175) provides access to a compartment having two or less internal power cells (530) within each compartment. Of course, each battery cap may provide access to a compartment having one or more internal power cells within each compartment. During operation of the integrated targeting device (100), a single compartment may have its internal power cells (530) replaced while the device maintains full operation, with the exception that where high peak power demand subassemblies (i.e. laser designator) are in use, full operation may not occur. However, the device may not lose situational awareness, including imaging of a target area, geolocation abilities, etc., during replacement of internal power cells (530) within a single compartment. In embodiments herein, the internal power cells may be in a series arrangement, but may have an electronic latch to close open circuits, thereby allowing the unit to operate using less voltage. Certain systems within the integrated targeting device may require high voltage (e.g., laser designator, laser rangefinder), but other systems may require low voltage (e.g., situational awareness data) may continue to be functional during replacement of internal power cells. Full functionality of the integrated targeting device may be maintained if power is augmented by an external power supply during replacement of internal power cells

In embodiments of the integrated targeting devices described herein, the laser output aperture (165) is a common output aperture optically aligned with the laser module (505). The laser module (505) is disposed within the housing (105) and is configured to perform laser rangefinding, laser illuminating, and laser designating. The laser module (505) comprises a seed laser configured to emit a seed laser beam and a moveable optical reflector configured to move between a first position and a second position. When the optical reflector is in the first position, the seed laser beam is directed through a first optical train configured to emit a laser designator beam having a first wavelength onto the selected target. When the optical reflector is in the second position, the seed laser beam is directed through a second optical train configured to pass through a optical parametric oscillator in order to emit a laser rangefinder beam having a second wavelength onto the selected target. The first wavelength and the second wavelength are different. In some embodiments, the seed laser is a diode-pumped Nd:YAG laser having a passively Q-Switched intracavity arrangement.

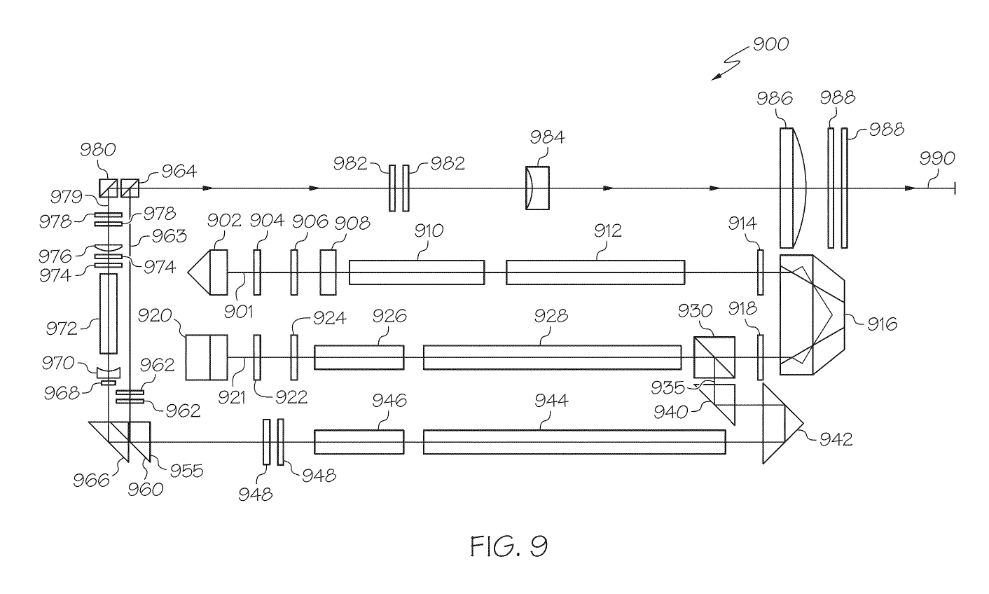

Referring to FIG. 9, depicted is a schematic representation of an exemplary optical layout for a laser rangefinder/illuminator and laser designator using a common output laser aperture. In operation, a first thermally efficient pump diode (902) generates a first light beam (901) that passes through a number of optical elements (904, 906, 908, 910, 912, and 914) in order to allow the pulses to be separated and cleaned prior to reaching Q-switch (912), which allows for a giant pulse formation. The first light beam (901) passes through wave plate (904) to shift the polarization of the laser, resonator (906) to reflect the laser internally until clean and peak power output is attained, lens (908) to focus the beam on the optical path extender (910)), which allows the light beam pulses to be separated cleanly before reaching the Q switch (912). The first light beam (901) then passes through another wave plate (914). The first light beam (901) is then redirected using corner cube (916) to change the direction of the laser so that it passes through wave plate (918) to ensure that the laser is properly polarized before entering the beamsplitter (930).

Still referring to FIG. 9, a second thermally efficient pump diode (920) generates a second light beam (921) that passes through a number of optical elements (922, 924, 926, and 928), which like the first light beam (901), process the second light beam (921). The second light beam (921) passes through wave plate (922) to shift the polarization of the laser, resonator (924) to reflect the laser internally until clean and peak power output is attained, oscillator/amplifier (926) to gain more power before going through optical path extender (928). The optical path extender (928) synchronizes and cleans the second light beam (921) before combining the second light beam (921) with the first light beam (901) at the beamsplitter (930). The first light beam (901) and second light beam (921) are combined using beam splitter (930) to produce a seed laser beam (935).

The seed laser beam (935) passes through a number of optical elements (940, 942, 944, 946, 948 and 950). The seed laser beam (935) passes through optical reflector (940) and optical reflector (942) where the seed laser beam is reflected to pass through optical path extender (944) to allow the laser beam to be separated and cleaned, oscillator/amplifier (946), and a risley pair (948), which steers the seed laser beam. The seed laser beam (935) then passes through moveable optical reflector (955). When the optical reflector (955) is in a first position (960), the seed laser beam (935) passes through a risley pair (962) to steer the beam to a set of optics (982-988), and has a first wavelength. The resultant laser beam is a designator laser beam (963). The designator laser beam (963) passes through beam splitter (964), where it is reflected and passes through a risley pair (982) to steer the beam, telescoping lens (984), optical lens (986) and a risley pair (988) to produce output laser beam (990), which exits through output aperture (165) of the integrated targeting device. When the optical reflector (955) is in a second position (966), the seed laser beam (935) passes through pump lens (968), a high reflective lens (970), optical parametric oscillator (972), corrective optics (974), output coupler (976), a risley pair (978), and has a second wavelength. The pump lens (968) and a high reflective lens (970) ensures that as much of the laser as possible reaches the optical parametric oscillator (972). The optical parametric oscillator shifts the wavelength of the seed laser to a rangefinder wavelength. The resultant laser beam is a rangefinding laser beam (979). The rangefinding laser beam (979) passes through beam splitter (980), where it is reflected and passes through a risley pair (982), telescoping lens (984), optical lens (986) and a risley pair (988) to produce output laser beam (990), which exits through output aperture (165) of the integrated targeting device. It should be understood that elements of this schematic are merely exemplary, and the ordering of the elements or additional elements may be included to improve overall laser quality, energy, etc.

In embodiments herein, the first wavelength may range from about 1000 nm to about 1100 nm, from about 1050 nm to about 1075 nm. In some embodiments, the first wavelength may be about 1064 nm. In embodiments herein, the second wavelength may range from about 1500 nm to about 1600 nm, from about 1525 nm to about 1575 nm. In some embodiments, the second wavelength is about 1550 nm. In other embodiments, the second wavelength is about 1560 nm.

The components depicted may be optically coupled to each other so as to produce the output laser beam (990) described herein for use in laser rangefinding (using eye-safe and non-eyesafe wavelengths), laser illuminating, and laser designating. In some embodiments, the laser designator may be used for rangefinding purposes while actively marking for laser guided munitions targeting. As used herein, two elements that are “optically coupled” means that elements are physically disposed such that some or all of an optical emission (e.g., light or laser beam) from one of the elements is transferred to or reflected by the other element (or vice versa) optically coupled thereto. When two elements are optically coupled, they may be in physical contact with each other, attached to each other, and/or suitably aligned (e.g., disposed relative to one other and either in contact with each other or not in contact with each other) to achieve the desired result.

The laser beams, including the first light beam, second light beam, seed laser beam, rangefinder laser beam, and designator laser beam, are folded or reflected, instead of having the beams travel all in one direction, so as to miniaturize the laser module. In embodiments of the integrated targeting devices described herein, the laser module may comprise one or more corner cubes, which permit a more compact laser module due to the multi-angular and multi-directional folding action of the laser beam that it creates. In some embodiments, the laser module may be sized less than 11 cubic inches, 9 cubic inches, 8 cubic inches, or 6 cubic inches.

The output laser beam may operate in either continuous wave (“CW”) mode, in which a laser beam is continuously produced, or in a pulsed (“QCW”) mode, in which a laser beam is produced only at certain times or under certain conditions. In some embodiments, the output laser beam may be pulsed at high repetition rates such that the output laser may illuminate a target. Illumination of the target may occur under low or no light conditions. The output laser may be pulsed at a rate of greater than about 100 Hz, about 1000 Hz, about 5000 Hz, about 10,000 Hz, about 15,000 hz, about 20,000 Hz, about 25,000 Hz, or about 50,000 Hz in order to illuminate a target. In some embodiments, the laser rangefinder beam is pulsed at a rate of greater than about 100 Hz, about 1000 Hz, about 5000 Hz, about 10,000 Hz, about 15,000 hz, about 20,000 Hz, about 25,000 Hz, or about 50,000 Hz in order to illuminate a target. The pulsed rate may be higher depending upon the target reflectivity and target distance. The laser controller module may permit the laser to operate in a variety of pulsed mode.

In embodiments herein, the Q-switch may comprise either an active or a passive Q-switch. For the purposes of this disclosure, references made to a Q-switch may apply to either an active or passive Q-switch. There are at least two types of active Q-switches which may be used, an EO (electro-optic) Q-switch or an AO (acousto-optic) Q-switch, and either type of active Q-switch may be actively controlled by a controller. That is the active Q-switch may be electrically coupled to the controller such that the controller is capable of directly controlling the on/off characteristics of the active Q-switch. In addition to a controller, the active Q-switches may also require relatively high voltage to operate. Thus, active Q-switches may require more space and energy and may produce relatively high levels of electromagnetic radiation.

Passive Q-switches may permit the laser to operate with both high and low repetition rates. Operation of the passive Q-switch may be controlled indirectly by the amount of light energy introduced into the passive Q-switch by, for example, the pump light source. Consequently, the operation of the passive Q-switch may depend on the type of pump light source used. In one embodiment, one or more of the diode bars in the pump diode may emit light at a wavelength which may be absorbed by the passive Q-switch. For example, as set forth above, one type of passive Q-switch may absorb light having a wavelength of 940 nm. The passive Q-switch can eliminate the large sized Q-switch controller that may be used with active Q-switches and the amount of power consumption, particularly when, for example, the Q-switch is operating at a high repetition (or pulse) rate where the rangefinder laser is operating as an illuminator. In some embodiments, the Q-switch is a passive Q-switch.

The Q-switch may have two states when in pulsed mode. In one state, the Q-switch may be turned off so as to block the output laser beam from exiting the laser, while in the other state the Q-switch may be turned on so as to allow the laser beam to exit the laser. In this fashion, the Q-switch may allow the laser beam to be pulsed. When the Q-switch is turned off, the energy level of the laser light may build or increase allowing the laser to be able to produce bursts of the laser beam having a very high peak power for a relatively short time duration. Thus, pulsed mode may allow bursts of a high-energy laser beam using the same energy and producing the same or less heat as a continuous, lower-energy laser beam when operating in CW (continuous wave) mode. The laser system may perform functions that more powerful lasers normally perform (e.g., designate targets per Standardization Agreement (“STANAG”) 3733) due to its utilization of a high peak power which is pulsed at a high rate rather than as a continuous wave. This high rep rate peak power laser allows the designator laser spot to be seen by laser guided munitions and is not negatively affected by the off time between pulses of the laser. The pulsing of the laser power allows the systems to run cooler and consume less power.

Below, Table 1 provides modeling of the approximate number of photons emitted at the laser output aperture for pulsed lasers as compared to continuous wave lasers. Modeling for the continuous wave laser was for a duration of 1 msec. The laser pulse rate is 1 Hz.

TABLE 1

| | Repetition | Energy | | Pulse | Photons at |
|---|---|---|---|---|---|
| Wavelength (nm) | Rate | per Pulse | | Duration (ns) | Aperture |
| 860 (CW) | NA | NA | | NA | 10.5K |
| (Laser Pointer) | | | | | |
| 1064 (Pulsed) | 15 | 90 | mJ | 20 | 16200K |
| (Laser Designator) | | | | | |
| 1540 (Pulsed) | 1 | 3 | mJ | 5 | 32K |
| (Laser Rangefinder) | | | | | |
| 1064 (Pulsed) | 15 | 30 | mJ | 20 | 5400K |
| (Laser Designator) | | | | | |
| 1550 (Pulsed) | 10000 | 1.0 | μJ | 1 | 107K |
| (Laser Rangefinder) | | | | | |

Table 1 indicates that with proper integration time and by the signal processing electronics or selecting proper pulse rate specific to each laser, photon budgets can be tuned for viable spot detection at a particular distance (e.g., 3 km or 5 km) using VIS and/or SWIR imaging cameras. Table 1 further indicates that the laser output power in pulsed mode is high as compared to continuous wave mode.

Below, Table 2 provides modeling of the approximate number of photons emitted at the laser output aperture for pulsed lasers as compared to continuous wave lasers in view of the typical atmospheric transmittance for the different laser wavelengths. The laser pulse rate is 1 Hz.

| | Atm | Energy | | Pulse | Photons at |
|---|---|---|---|---|---|
| Wavelength (nm) | Transmission | per Pulse | | Duration (ns) | Aperture |
| 860 (CW) | 0.96 | NA | | NA | 10500K |
| (Laser Pointer) | | | | | |
| 1064 (Pulsed) | 0.92 | 90 | mJ | 20 | 1080K |
| (Laser Designator) | | | | | |
| 1540 (Pulsed) | 0.72 | 3 | mJ | 5 | 32K |
| (Laser Rangefinder) | | | | | |
| 1064 (Pulsed) | 0.92 | 30 | mJ | 20 | 360K |
| (Laser Designator) | | | | | |
| 1550 (Pulsed) | 0.72 | 1.0 | μJ | 1 | 11K |
| (Laser Rangefinder) | | | | | |

Table 2 indicates that when significantly less power is used in the laser systems as shown in Table 2 (90 mJ designator versus 30 mJ designator), the resultant photons at the detector are lower. Thus, in terms of spot detection, the imaging camera used for detection may require error correction of the resultant images, or a more sensitive camera with a denser pixel count in order to visualize the laser spots at operational ranges of 3 km.

In embodiments of the integrated targeting devices described herein, the laser module may comprise one or more thermally efficient pump diodes. The thermally efficient pump diodes may comprise one or more multi-light-emitting diodes or bars, one or more spacers (or thermally conductive spacers), that may be disposed between and separate the diode bars such that they conduct heat away from the diode bars, and substrates used as supports for the diode bars and spacers. The substrates may include a recess or indentation for receiving the diode bars and spacers. Examples of light-emitting diodes bars and spacers are disclosed in U.S. Pat. No. 7,529,286 issued May 5, 2009 to Gokay et al., and U.S. Pat. No. 8,204,094 issued Jun. 19, 2012 to Gokay, both of which are herein incorporated by reference. In embodiments herein, diode bars emitting multiple wavelengths of light may be used in order to create a wider temperature range of operation with minimal thermal management devices (e.g., heat sinks).

In embodiments of the integrated targeting devices described herein, the laser module may comprise an oscillator module and/or one or more amplifier modules. Examples of oscillator modules and/or amplifier modules are disclosed in U.S. Pat. No. 8,204,094 issued Jun. 19, 2012 to Gokay, which is herein incorporated by reference. In some embodiments, the one or more amplifier module may be optically coupled to the oscillator module so as to further increase the power level of the laser beam. The amplifier module may comprise one or more pump light sources. Any suitable number of amplifier modules may be added in order to increase the power level of the laser beam to the desired level.

Not to be limited by theory, the pump light sources may allow high pump concentration or excitation in the gain medium with improved broadband wavelength pumping conversion efficiencies. Because of the efficiency improvements, a thermal management system may require only heating. This may be accomplished by connecting self-heating resistance heaters or TEC devices (e.g., thermo-electric cooling devices) to the oscillator module (e.g., connected to a top surface of the oscillator module) to bring the laser system to the operational temperature range during the start up period. Due to the low mass of both the oscillator module and amplifier module, both modules may be preheated quickly. This may eliminate the need for TEC-regulated inefficient conventional thermal management hardware and control systems. If the application requires cooling and heating simultaneously, multiple TEC devices may be used to pre-cool and heat both the oscillator module and amplifier modules. Regardless of the thermal management system, waste heat may be conductively dissipated (e.g., without using heat dissipating fins or fans, or fluid cooling). This may allow the internal components of the integrated targeting device to be closer in proximity, thereby allowing the device to be more compact.

In embodiments of the integrated targeting devices described herein, the laser module may include one or more waveplates in order to shift the polarization of the laser, one or more Risley pairs to steer the laser, one or more resonators to reflect the laser internally until a peak and clean power output is attained, an output coupler, and one or more lenses. Examples of lenses may include a focusing lens to focus the beam. The output coupler may be used to facilitate the operation of the laser by reflecting some of the laser light while allowing the remaining laser light to pass through it so as to form a laser beam. The laser beam produced by the compact laser module may have substantially the same characteristics as if all the optical components were aligned in a straight line. In embodiments of the integrated targeting devices described herein, the laser module may include thermally-conductive, optically-transparent devices which operate to remove heat generated by the operation of the laser. Such devices allow the laser module to stay cool without heat dissipating fins or fluid cooling. As such, the illustrative laser module as described herein may have improved efficiency, increased average power, increased operating temperature range, and reduced size and/or weight characteristics.

In embodiments herein, the laser module may be capable of generating a laser beam having output energy of 10 to 15 mJ, an output pulse width of 16 to 22 ns, a beam diameter of 12 to 14 mm, and a beam divergence of less than about 0.5, less than about 0.4, or less than about 0.3 milliradians. The laser module may be capable of generating such a laser beam by using some or all of the novel features described herein. The laser module may weigh between 300 to 500 grams and may be about 110 mm in length and about 50 mm in width and height. In embodiments herein, modular oscillator amplifier stages, as shown in FIG. 9, may allow the laser to have more power as required for a particular application. In some embodiments, a 30 mJ laser having an oscillator amplifier stage for ranges of 3 km is utilized.

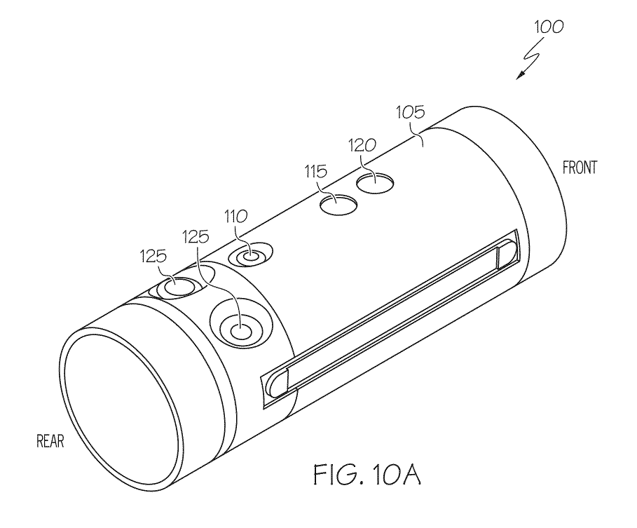

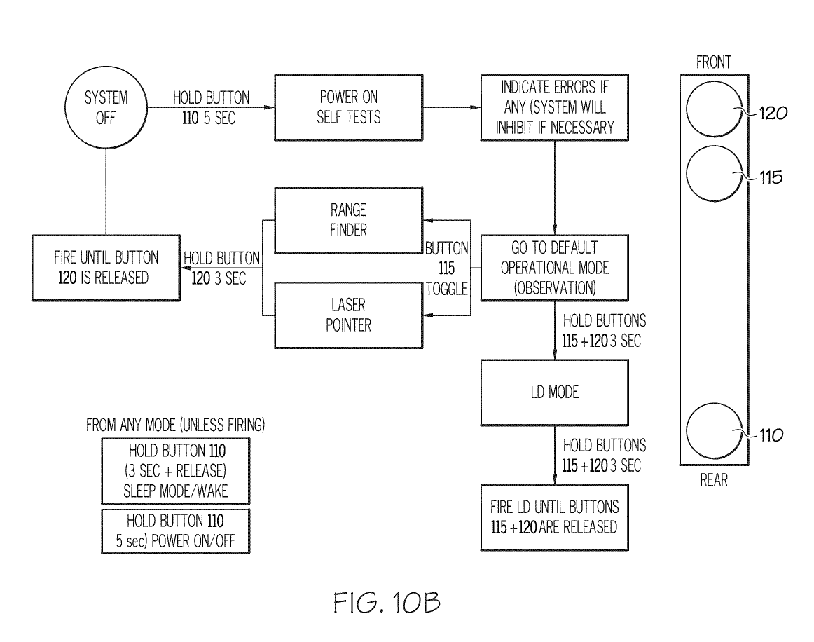

The integrated targeting device may further comprise a user interface, which may include buttons, a graphical user interface, or other interface capable of operating the integrated targeting device. Referring to FIGS. 1A and 10A, depicted on the housing (105) are three user-depressible push button switches (110, 115, 120) configured to control the operation of the integrated targeting device (100). Referring to FIGS. 3 and 10B, the integrated targeting device may utilize a FPGA (Field-Programmable Gate Array) based hardware and software featuring three (3) momentary switches. The user may fully operate the device using one hand only using a series of buttons taps and combinations similar to what is shown in FIG. 10B.

In operation, the integrated targeting device emits a laser rangefinder beam from a laser module and directs the rangefinder beam onto a target area. The integrated targeting device collects reflected energy of the laser rangefinder beam that is reflected by the target area and directs the energy to the imaging module, where an image of the target area is captured. A portion of the reflected energy is also collected by the rangefinder pin detector. The integrated targeting device emits a laser designator beam from the laser module and directs the designator beam onto the target. Energy from the designator beam is reflected by the target, and the integrated targeting device collects the reflected energy and directs the energy to the imaging module.

In embodiments of the integrated targeting devices described herein, arrangement, orientation, packaging and proximity of the major critical subassemblies (e.g., geolocation module, input optical train, imaging module, and laser module) and their supporting elements (e.g., PCBs, optics, etc.) may be considered to avoid creating thermal, EMI (electromagnetic interference) and shock resistance issues that may occur during operation.

Thermal studies may be conducted using a temperature probe or other acceptable method around the highest power and peak power draw devices during operation. Examples of some of the high power and peak power draw devices may include, for example, the laser module, the imaging module, and their supporting elements, such as a voltage regulation board. The thermal studies may be performed to ensure that the operational temperature does not exceed a threshold where damage could be caused to another component or cause the component to perform outside its acceptable operating range. For example, the heat produced by adjacent components can cause either the laser module or pointer laser to drift off target and outside of the acceptable range.

EMI studies may be conducted to ensure that electronic components of the integrated targeting device do not have a significant impact on subassemblies that may be easily affected by magnetic fields. Examples of such subassemblies can include, but are not limited to, the GPS/antenna and digital magnetic compass. In order to isolate these components from electromagnetic interference, in some embodiments, the GPS/antenna and digital magnetic compass may be located on the outermost portion of the integrated targeting device housing. In addition, in some embodiments, shielding may be employed to sufficiently create a Faraday Cage around the electronic components or the Faraday Cage may be employed in such a way that the electric field of the electronic components are effectively isolated from the magnetically affected components in the rest of the integrated targeting device. Measurements of the electric and magnetic field may be performed to determine the effectiveness of shielding and any operational impact to the overall targeting device.

Placement of the subassemblies and their supporting components may be selective to allow them to be stably braced and better potted to more effectively handle shock scenarios such as running and being dropped. In addition, the housing of the integrated targeting device may have an outer skin made from a durable material, including, for example, acrylonitrile butadiene styrene, Bayblend® or other durable materials that have a high tensile strength and sufficient elasticity to absorb shock so as to avoid damage to internal components. In some embodiments, the integrated targeting device may be able to absorb shock and avoid damage to internal components from drops less than about 48″, about 36″, about 30″, or about 24″. The outer skin may be easily attachable and removable in the event that it needs to be replaced. The outer skin may be a camouflage outer skin not easily detectable to the unaided human eye.

In embodiments of the integrated targeting devices described herein, the integrated targeting device may be modular in nature allowing for simplified maintenance and upgrade of individual subsystems as technology evolves and/or improved subsystems become available. In embodiments herein, the integrated targeting device may allow for maintenance and/or upgrade of, for example, the imaging focal plane array, input optical train, laser, laser pointer, celestial/inertial navigation system, GPS system, digital magnetic compass, user display, processor and/or external interface connections. In some embodiments, complete modules may be replaced, for example, a complete replacement of the geolocation module and/or the targeting module. For example, the targeting module and shell may be extended in length in order to improve visualization ranges (detect, recognize and identify according to Johnson's Criteria) by extending the optics train. The geolocation module may remain the same due to the modular design of the integrated targeting device.

In addition, the modular design would allow for failure of some subsystems, while maintaining virtually full operation on other subsystems. For example, if the observation system fails, other systems could still function (e.g., geolocation system). Or if the celestial/inertial navigational system fails, other systems, such as, for example, the laser rangefinder and all other geolocations subsystems (GPS and digital magnetic compass) may still be operational. If the laser module fails, the integrated targeting device may still act as an effective observation unit. If the on-board power supply fails, the integrated targeting device may still operate using an external power supply. If the display fails, observation may be had through an external viewer, e.g., a laptop computer, wrist computer, helmet display, or other similar external display device.

In embodiments of the integrated targeting devices described herein, the integrated targeting device may require a certain level of concealment from detection by an enemy. The integrated targeting device may have a light discipline to protect from producing luminary notifications that would allow detection at distances of greater than about 20 m, about 25 m, about 30 m, or about 50 m. Light discipline may be accomplished through the use of a polarizing filter. The integrated targeting device may have a noise discipline to protect from producing auditory notifications or other noises that would allow for detection at distances of greater than about 20 m, about 25 m, about 30 m, or about 50 m. The integrated targeting device may have a odor discipline to protect from the production of odor notifications that would allow for detection at distances of greater than about 20 m, about 25 m, about 30 m, or about 50 m.

In embodiments of the integrated targeting devices described herein, the integrated targeting device may require the ability to withstand environmental effects. The integrated targeting device may be able to withstand operational E³ (Electromagnetic Environmental Effects). This may be accomplished, for example, using an aluminum shell, which may act as a Faraday cage. Of course, other suitable methods for producing an integrated targeting device that is able to withstand operational E³ may be used. The integrated targeting device may be able to withstand low pressure environments, when operating at high altitudes. That is, the components within the integrated targeting device may not be affected or minimally affected by pressure changes. The integrated device may be able to withstand and operate in low temperatures (for example, at or below −20° F./−28.9° C.) and high temperatures (for example, at or above 131° F./+55° C.). While many of the subassemblies of the device are capable of operating within these temperatures, the batteries may require warming once depleted in order to be charged. During operation at low temperatures, waste heat from the Laser Rangefinder/Designator (laser module) may warm the batteries to 0° C. for charging to start. The integrated targeting device may also have HVAC circuits to regulate the battery housing temperature. In some embodiments, the battery HVAC system uses phase change material to capture and release heat as needed for the batteries. In other embodiments, the battery HVAC system may include the use of strip heaters within the battery housing. Monitoring of the battery temperature regulation may be accomplished using the processor.

It should now be understood that the devices and methods described herein may be used to increase the efficiency of a integrated targeting device, to improve the transfer of heat away from various components within the integrated targeting device, and to minimize the physical size and weight of the integrated targeting device with minimal change in functionality, output energy and/or power. The embodiments of the integrated targeting device described herein may be used in military, medical, and industrial applications. For example, one embodiment may be used as a directed energy weapons system.

While particular embodiments and aspects of the present disclosure have been illustrated and described herein, various other changes and modifications may be made without departing from the spirit and scope of the disclosure. Moreover, although various aspects have been described herein, such aspects need not be utilized in combination. It is therefore intended that the appended claims cover all such changes and modifications that are within the scope of this disclosure.

What is claimed is:

1. An integrated targeting device comprising:
a housing, the housing comprising an input aperture and an output aperture;
a geolocation module configured to estimate the geolocation of a selected target;
an imaging module optically aligned with the input aperture, the imaging module comprising an infrared focal plane array configured to receive electromagnetic radiation in the near infrared and short wavelength infrared spectral range;
a laser module optically aligned with the output aperture, the laser module comprising
a seed laser configured to emit a seed laser beam; and
a moveable optical reflector configured to move between a first position and a second position, wherein when the optical reflector is in the first position, the seed laser beam is directed through a first optical path configured to emit a laser designator beam having a first wavelength onto the selected target, and when the optical reflector is in the second position, the seed laser beam is directed through a second optical path configured to emit a laser rangefinder beam having a second wavelength onto the selected target, wherein the first wavelength≠the second wavelength;
a rangefinder module optically aligned with the input aperture, the rangefinder module comprising a rangefinder pin detector configured to determine a flight time of the rangefinder laser beam;
a display associated with the imaging module, the display configured to display an image output; and
a processor operatively coupled to the laser module, the imaging module, the geolocation module, the rangefinder module and the display.

2. The device of claim 1, further comprising a power supply disposed within the housing.

3. The device of claim 1, further comprising an input optical train optically aligned with the input aperture and the imaging module.

4. The device of claim 1, wherein the housing further comprises a laser pointer aperture, and the device further comprises a laser pointer aligned with the laser pointer aperture.

5. The device of claim 4, wherein the laser pointer is night vision goggle compatible.

6. The device of claim 1, wherein the housing has a replaceable outer skin.

7. The device of claim 1, wherein the geolocation module comprises at least one of a celestial/inertial system, a global positioning system or a digital magnetic compass.

8. The device of claim 7, wherein the housing further comprises at least one celestial aperture, and the celestial/inertial system comprises at least one celestial camera for imaging a celestial object, the at least one celestial camera being optically aligned with the at least one celestial aperture.

9. The device of claim 1, wherein the geolocation module comprises a celestial/inertial system, a global positioning system and a digital magnetic compass.

10. The device of claim 1, wherein the laser rangefinder beam has an eye-safe wavelength.

11. The device of claim 1, wherein the laser rangefinder beam is configured to operate at a high pulse repetition rate such that objects may be illuminated in low lighting conditions.

12. The device of claim 11, wherein the high pulse repetition rate is greater than about 100 Hz.

13. The device of claim 1, wherein the laser designator beam is encoded using a pulse coding system.

14. The device of claim 1, wherein the rangefinder pin detector is further configured to determine a flight time of the laser designator beam.

15. The device of claim 1, wherein the geolocation module, the imaging module and the laser module operate independently of each other such that if one module fails, the other modules may continue to operate.

16. The device of claim 1, wherein the imaging module further comprises a visible light focal plane array configured to receive electromagnetic radiation in the visible light spectral range.

17. The device of claim 1, wherein the integrated targeting device is configured for eye-safe viewing.

18. The device of claim 1, wherein the processor is programmed to perform image error correction by one or more of:
superimposing one or more of a laser designator spot, a laser rangefinder spot, or a laser pointer spot onto the image output and enhancing the spot intensities;
moving laser beams using the laser module to actively boresight one or more of a laser designator spot, a laser rangefinder spot, or a laser pointer spot, such that the one or more of the laser designator spot, the laser rangefinder spot, or the laser pointer spot are aligned and overlaid on the image output;
overlaying relevant laser spots, one at a time, on the image output;
implementing pulse width modulation techniques to alter the duty cycle, such that the amount of backlight interference is reduced and the image output is enhanced; and
synchronizing the imaging module with the laser module and a variable gain control such that a different luminescence of the target results.

19. A modular integrated targeting device comprising:
a housing, the housing comprising an input aperture, a laser output aperture and a laser pointer output aperture;
a geolocation module, the geolocation module comprising a processor, a display, and at least one of a celestial/inertial navigation system, a global positioning system (GPS), or a digital magnetic compass; and
a targeting module, the targeting module comprising:
a laser comprising:
a seed laser configured to emit a seed laser beam; and
a moveable optical reflector configured to move between a first position and a second position, wherein when the optical reflector is in the first position, the seed laser beam is directed through a first optical path configured to emit a designator laser beam having a first wavelength toward the selected target, and when the optical reflector is in the second position, the seed laser beam is directed through a second optical path configured to emit a laser rangefinder beam having a second wavelength onto the selected target, wherein the first wavelength≠the second wavelength;
a rangefinder pin detector configured to determine a flight time of the rangefinder laser beam; and
an input optical train optically aligned with input aperture, the imaging focal plane array and the rangefinder pin detector, the input optical train comprising one or more lenses and configured to direct incoming electromagnetic radiation from the input aperture to the imaging focal plane array and the rangefinder pin detector.

20. The device of claim 19, further comprising a power supply disposed within the housing.

21. The device of claim 19, wherein the device further comprises a laser pointer aligned with the laser pointer aperture.

22. The device of claim 21, wherein the laser pointer is night vision goggle compatible.

23. The device of claim 19, wherein the housing has a replaceable outer skin.

24. The device of claim 19, wherein the housing further comprises at least one celestial aperture, and the geolocation module comprises a celestial/inertial system comprising at least one celestial camera for imaging a celestial object, the at least one celestial camera being optically aligned with the at least one celestial aperture.

25. The device of claim 19, wherein the geolocation module comprises a celestial/inertial system, a global positioning system and a digital magnetic compass.

26. The device of claim 19, wherein the laser rangefinder beam has an eye-safe wavelength.

27. The device of claim 19, wherein the laser rangefinder beam is configured to operate at a high pulse repetition rate such that objects may be illuminated in low lighting conditions.

28. The device of claim 27, wherein the high pulse repetition rate is greater than about 100 Hz.

29. The device of claim 19, wherein the laser designator beam is encoded using a pulse coding system.

30. The device of claim 19, wherein the rangefinder pin detector is further configured to determine a flight time of the laser designator beam.

31. The device of claim 19, wherein the geolocation module, the imaging module and the laser module operate independently of each other such that if one module fails, the other modules may continue to operate.

32. The device of claim 19, wherein the imaging module further comprises a visible light focal plane array configured to receive electromagnetic radiation in the visible light spectral range.

33. The device of claim 19, wherein the integrated targeting device is configured for eye-safe viewing.

34. The device of claim 19, wherein the processor is programmed to perform image error correction by one or more of:
superimposing one or more of a laser designator spot, a laser rangefinder spot, or a laser pointer spot onto the image output and enhancing the spot intensities;
moving laser beams using the laser module to actively boresight one or more of a laser designator spot, a laser rangefinder spot, or a laser pointer spot, such that the one or more of the laser designator spot, the laser rangefinder spot, or the laser pointer spot are aligned and overlaid on the image output;
overlaying relevant laser spots, one at a time, on the image output;
implementing pulse width modulation techniques to alter the duty cycle, such that the amount of backlight interference is reduced and the image output is enhanced; and
synchronizing the imaging module with the laser module and a variable gain control such that a different luminescence of the target results.
